(19) United States
(12) Patent Application Publication
(10) Pub. No.: US 2005/0027573 A1
(43) Pub. Date: Feb. 3, 2005

(54) System architecture and a method for customer flow management

(76) Inventor: Assaf Silberstein, Beit-Zayit (IL)

Correspondence Address: KATTEN MUCHIN ZAVIS ROSENMAN, 575 MADISON AVENUE, NEW YORK, NY, 10022-2585, US

(21) Appl. No.: 10/628,833

(22) Filed: Jul. 28, 2003

(51) Int. Cl. G06F 17/60

(52) U.S. Cl. 705/7; 705/8

(57) ABSTRACT

An open-architecture system for queue management of users that is hardware independent, wherein the system includes at least one Web-based server for an organization containing the logic and central systems functions. The system also includes a Web client application allowing interaction between the users and the web-based server, and which is accessible through a browser on client workstations, a database installed on an Structured Query Language (SQL) server for record maintenance and interactions with the web-based server and the client application, an announcer server for activating displays, speakers, etc., according to orders from the Web-based server and an automated receptionist for issuing tickets to and otherwise interacting with users.

### FIELD OF THE INVENTION

The present invention relates to systems and methods for customer/user flow management. More particularly, the present invention relates to an integrated Web system architecture and a hardware independent method for queue management applications.

### BACKGROUND OF THE INVENTION

Queue Management Systems (QMS) is a term widely used to describe traditional solutions for Customer Reception and Flow Management (CRFM). Very simple QMS's are often referred to as “Take-a-Ticket” systems. CRFM consists of several elements which may be generally grouped into customer management, agent management, interaction management and service level management.

Customer management covers such topics as customer identification, ticketing, and guidance, e.g. “customer 123 go to room 456.” These topics are handled well by existing QMS's, except where customer identification requires complex integration with enterprise databases. QMS's are also limited in the use of customer guidance tools, such as displays, speakers, etc., which are usually supplied by the QMS vendor.

Agent management covers topics such as staffing and productivity monitoring. These topics are only handled by the most advanced QMS's.

Interaction management covers features such as appointment management and screen pop-ups, and requires seamless integration with enterprise CRFM software and Web applications. Existing QMS's are closed architecture systems, making them very difficult to integrate.

A .Net application is developed using developer tools, such as Microsoft Visual Studio for .NET (hereinafter, the “VS Net”), which provides an integrated development environment (IDE) for maximizing programmer productivity with the .NET framework. The VS .Net allows a programmer to create, compile, debug and execute a Net application using one or a combination of the above mentioned programming languages. The VS .Net framework provides developers with a unified, object-oriented, hierarchical, and extensible set of class libraries. By creating a common set of Applications Programming Interfaces (API's) across all programming languages, the common language runtime enables cross-language inheritance, error handling and debugging.

Developments in the art include U.S. Pat. No. 4,675,647, System for Determining a Queue Sequence for Serving Customers at a Plurality of Service Points, by Salin, 1987. Salin teaches a system comprising a turn-number device with memory facilities and with the possibility for selection of a service point, an information unit connected to the device and designed to be able to indicate which mechanically ticketed turn-number is to be served next, and at which service point service is to be given.

U.S. Pat. No. 6,529,786 published in March, 2003, Queue Management System, by Sim, provides a queue management system which allows people who wish to queue to be free to undertake other activities. The time involved in physically queuing can be drastically reduced to perhaps a few minutes. The system maintains the place of users in each queue and informs them when they should physically join the queue.

Service level management, available in advanced QMS, requires constant monitoring of waiting times and queue lengths, but could also monitor parameters not covered by existing solutions, such as customer satisfaction.

Therefore, there is a need for a system and a method that overcomes the limitations of the prior art, and provides a NET, Web-based queuing system.

### SUMMARY OF THE INVENTION

Accordingly, it is a principal object of the present invention to overcome the limitations of prior art, and to provide Web-based system architecture and a method that is substantially hardware independent for queue management system applications.

It is still a further object of the present invention to provide open Web architecture, based on .NET technology, enabling greater flexibility and more intelligent applications.

It is still another object of the present invention to provide ease of integration, and advanced human engineering for the benefit of both customers/users and agents.

It is yet a further object of the present invention to provide innovative features and analytical tools

An open-architecture system for queue management of users is disclosed, that is hardware independent, wherein the system includes at least one Web-based server for an organization containing the logic and central systems functions. The system also includes a Web client application allowing interaction between the users and the web-based server, and which is accessible through a browser on client workstations, a database installed on an Structured Query Language (SQL) server for record maintenance and interactions with the web-based server and the client application, an announcer server for activating displays, speakers, etc., according to orders from the Web-based server and an automated receptionist for issuing tickets to and otherwise interacting with users.

The present invention is a software solution. However, since it needs to interact with users in the form of customers, service representatives (hereinafter referred to as agents) and managers, etc., it is usually provided bundled with hardware elements, such as ticket printers, electronic displays and so on. These elements are referred to as the hardware environment.

The present invention, hereinafter referred to as Q-Flow™, contains a few distinct software components. These components have different tasks, such as interacting with users, activating hardware, manipulating database records, etc.

Additional features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 is a schematic illustration of the hardware components comprising one exemplary embodiment, constructed in accordance with the principles of the present invention;

FIG. 2 is a block diagram of the software architecture of one preferred embodiment, constructed in accordance with the principles of the present invention;

FIG. 3 is a screen shot illustrating Info Center, in accordance with the principles of the present invention;

FIG. 3a shows detailed screen shot segments illustrating Management Info Center, in accordance with the principles of the present invention;

FIG. 4 is a screen shot illustrating Service Console, in accordance with the principles of the present invention;

FIG. 5 is an InfoPage screen shot on a TV or computer monitor, in accordance with the principles of the present invention;

FIG. 6 is a general screen shot of the Calendar application, in accordance with the principles of the present invention;

FIG. 6a shows detailed screen shots of the Calendar application, in accordance with the principles of the present invention;

FIG. 7 is a Receptionist screen shot on a TV or computer monitor, in accordance with the principles of the present invention; and

FIGS. 8a-8e are flow charts, constructed in accordance with the principles of the present invention.

### DETAILED DESCRIPTION OF THE INVENTION

The invention will now be described in connection with certain preferred embodiments with reference to the following illustrative figures so that it may be more fully understood. References to like numbers indicate like components in all of the figures.

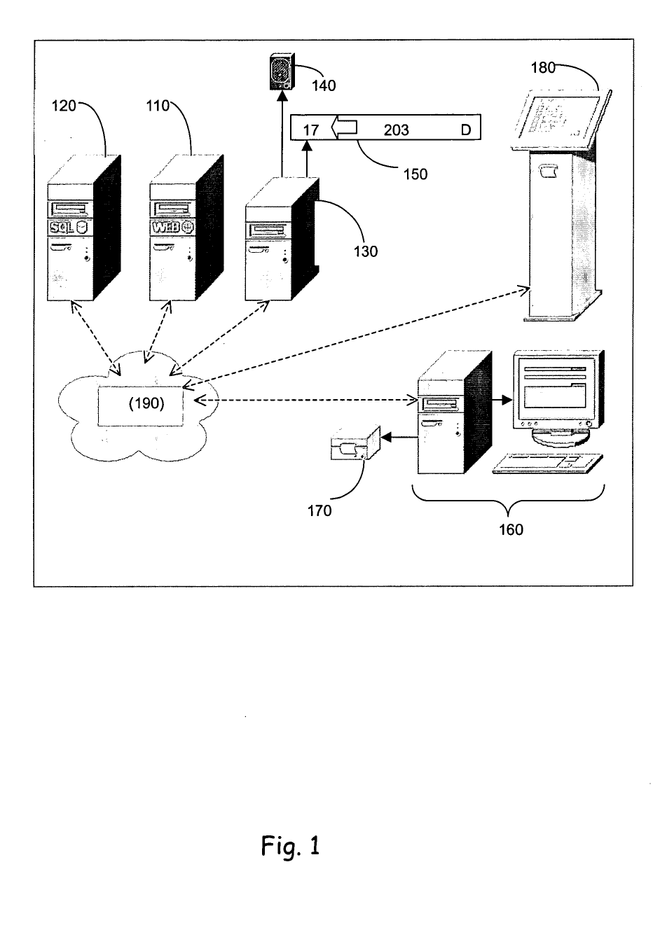

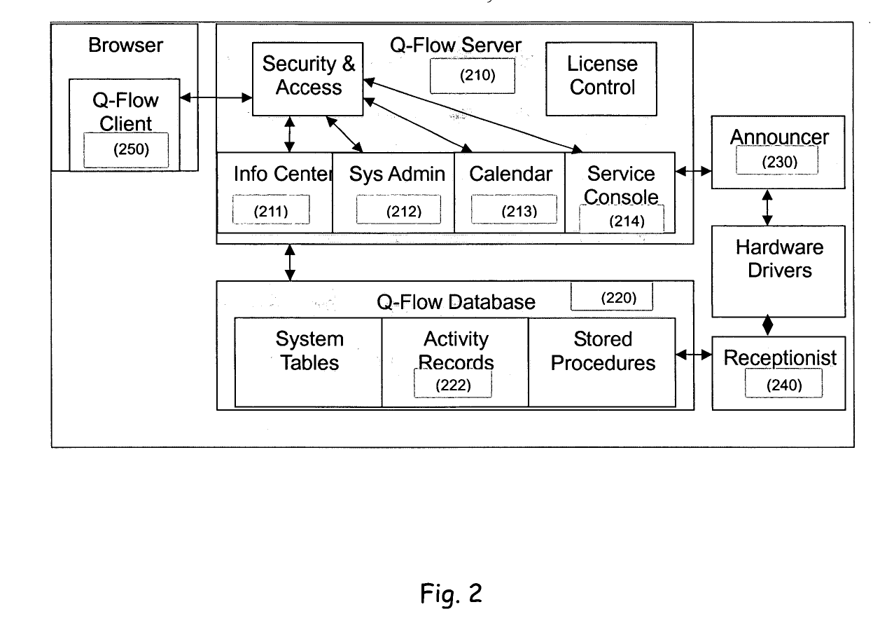

FIG. 1 is a schematic illustration of the hardware components comprising one exemplary embodiment, constructed in accordance with the principles of the present invention. FIG. 1 illustrates the hardware components that are usually found in the Q-flow environment. The environment may contain as many hardware elements, connected through the Web 190, as necessary for each type. The hardware components are described below in combination with the software architecture of FIG. 2.

FIG. 2 is a block diagram of the software architecture of one preferred embodiment, constructed in accordance with the principles of the present invention. These are the main 5 software components in Q-Flow:
Q-Flow Server 210 is installed on the Web Server 110 containing the system's “business logic” and performing most central system functions. Comprises 4 main sub-components:
Management Information Center 211; System Administration 212; Calendar 213; and Service Console 214;
Q-Flow Database 220 is installed on the Structured Query Language (SQL) Server 120, containing all records and performing database-level operations; SQL is a type of programming language used to construct database queries and perform updates and other maintenance of relational databases, SQL is not a full-fledged language that can create standalone applications, but it is strong enough to create interactive routines in other database programs.
Q-Flow Announcer 230 is installed on the Announcements Server 130, activating LED displays 150 AND speakers 140, as ordered by Q-Flow Server 210; Q-Flow Receptionist 240 is installed on Kiosk 180, or on a computer attached to an uncomputerized Kiosk, interacting with arriving customers and issuing them tickets; and
Q-Flow Client 250 is a Web GUI application, allowing interaction between users and Q-Flow Server 210, accessible through browser on client workstations 160, each typically connected to a ticket printer 170.

Both Management Info Center 211 and Service Console 214 are accessible by browser, using Q-Flow Client 250 GUI application.

Whereas for the prior art the proprietary hardware comprising wall displays, ticket printer etc., is an integral part of the QMS system, by contrast Q-Flow is a pure software solution. This means standard equipment may be connected to the system at will. The system communicates with such equipment using either standard drivers, for printers, speakers, etc., or specially customized drivers, usually for LED displays.

This enables users to have a wide choice of equipment to fit budget limitations, waiting room architectural features, preferred hardware suppliers, etc. The prior art either hardwires all components in star architecture, for example, around a central controller or switch-box, or combines hard-wiring with Web terminals running on a local controller. Terminal is QMS terminology for an agent-operated component, allowing service operations like calling the next customer or marking end of service Prior art QMS terminals are either software components running on a regular PC, or if PC software is not available, running on proprietary hardware devices. Q-Flow provides the capacity to use standard handheld devices, such as a pocket PC, or any handheld device equipped with an Internet browser with the Service Console. The console is designed with a flexible GUI, which can fit any size of display, including that of a handheld device. The architecture described above allows use of all standard Handheld Device communication forms, such as wired, wireless: WiFi or Bluetooth and Cellular. This allows users who do not have a full size PC in the service area, or who do not want to clutter the PC screen, which may be used for other business applications, to use the handheld device as a standard, off-the-shelf wired or wireless terminal.

Prior art QMS equipment, in particular LED Displays, Ticket Printers and Speakers, as above, is wired to a central switch, using proprietary cables or enterprise network cables. By contrast, Q-Flow provides the capacity to use wireless devices, including displays, printers and speakers, if they support standardized wireless protocols such as WiFi or Bluetooth. Use of wireless equipment allows an easier deployment of the system, with lower installation and maintenance costs.

Prior art QMS and Take-a-Ticket systems provide either pre-printed numbered tickets or tickets which are printed on the spot with a pre-defined format, with only the number and non-personal information, such as time of arrival or expected time of wait changing.

Prior art QMS uses one speaker per queue/service, in order to avoid clashing of announcements from more than one source on the speaker. In Q-Flow, Announcer contains a Message Queue mechanism, allowing messages from different sources to queue without clashing, so that one speaker may serve many queues/services, therefore saving money and simplifying deployment.

Q-Flow, in an exemplary embodiment, inserts personal information onto the ticket and onto the screen, if the ticketing device has a screen. Pre-defined format includes, in addition to fixed text and non-personal information, parameters containing customer ID, name, personal greeting and personal information, usually containing marketing info and offerings directed at that specific customer. Q-Flow also allows printing of attached documents, as defined per service type or specific customer ID. These documents may be: forms that need to be filled prior to meeting with the service agent; marketing brochures; etc. This allows the system to provide a personal touch to the automated reception kiosk, and to assist marketing efforts.

Q-Flow is a pure web, centralized solution. No local software installations are required, with the exception of Announcer 230 if any of the equipment does not have IP addresses. This enables users to minimize installation and maintenance costs. All administration, such as hardware configuration, business logic, users ID and passwords, etc., can be done from anywhere in the enterprise, affecting remote sites immediately. This architecture also makes the system much more suitable for Enterprise Application Integration.

Prior art QMS databases are closed and contain only data created internally by QMS activity. Activity Data Storage 222 on Q-Flow is an open architecture sub-system. It is understood that often, customer reception is not the agent's only activity, and the agent may also perform other types of service or general activities. Q-Flow enables importing of data from external service channels, mainly telephony, and also inputing of reports of general activity performed during agent log-out. This enables users to perform complete productivity analysis of agents and business units, taking all activity types into account, using Q-Flow Info Center 211 report generator.

Prior art QMS provides tabular, numerical analysis of percentage of agent's time spent during service, breaks, etc. It follows from Activity Data Storage 222, that Q-Flow database 220 may contain simultaneous or interfering agent activities. Q-Flow Info Center 211 features a unique report displaying all agent activities in the form of a “Gantt Chart” for visual clarity.

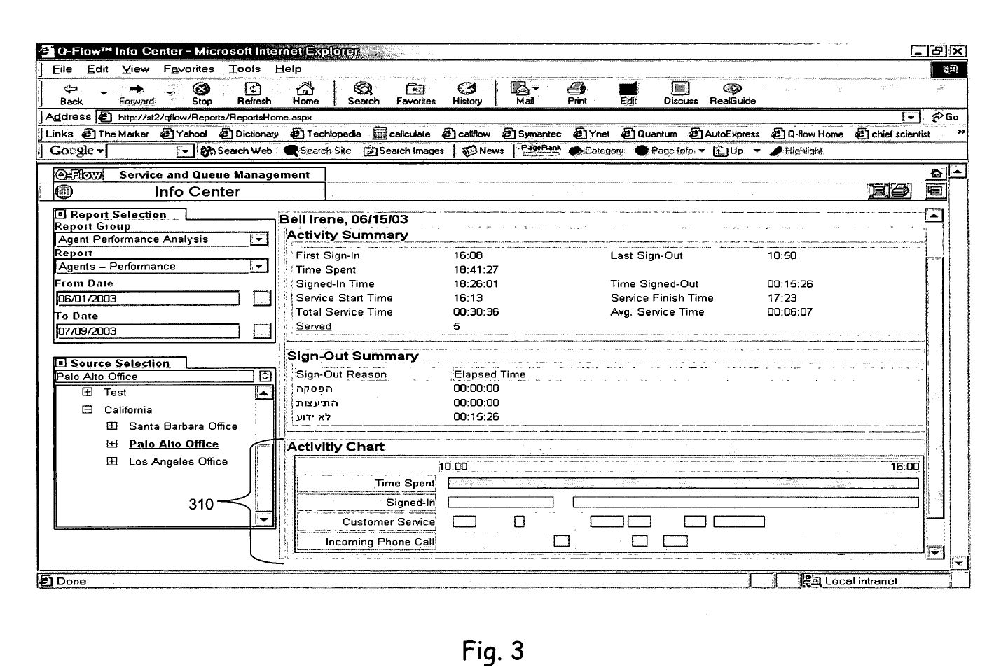

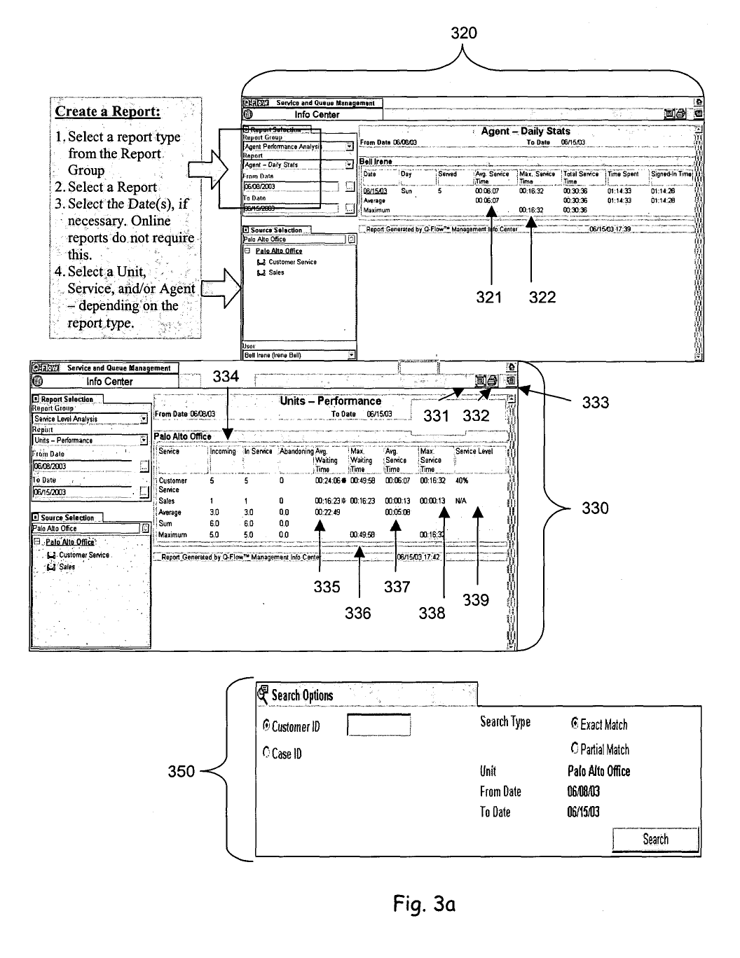

FIG. 3 is a general screen shot illustrating Management Info Center 211, in accordance with the principles of the present invention. A Gantt chart 310, showing agent activity, is a segment of this screen shot.

FIG. 3a shows detailed screen shot segments illustrating Management Info Center 211, in accordance with the principles of the present invention. Management Info Center 211 provides instant access to a wide range of reports and information, on specific Agents, and the performance of the Center as a whole. A Manager can produce detailed reports on Agent work stats, customer stats or performance of business units, to name a few.

A report creation window 320 is pictured with the steps involved in creating a report:

Select a report type from the Report Group;

Select a Report;

Select the Date(s), if necessary. Online reports do not require this; and

Select a Unit, Service, and/or Agent, depending on the report type.

Also shown are Service times listing Average 321 and Maximum 322 values for the Agent.

A report operations window 330 is pictured with the operations associated with a unit performance example:

Expand the Report: Click on the Expand Icon [symbol] 331;

Print a Report: Click on the Printer Icon [symbol] 332; and

Run the Report: Click on the Run Report Icon [symbol] 333.

The Level of Service is based on the Unit, including:

Incoming Customers per Service 334;

Average Wait 335, Max Wait 336, Avg. Service Time 337 and Max Svc. Time 338; and

Service Performance % Level 339.

A search options window 340 is pictured with a search options example:

The steps involved in a Data Search:

Select Search from Report Type;

Enter the Customer ID or Case ID;

Select Search Type; and

Click Search.

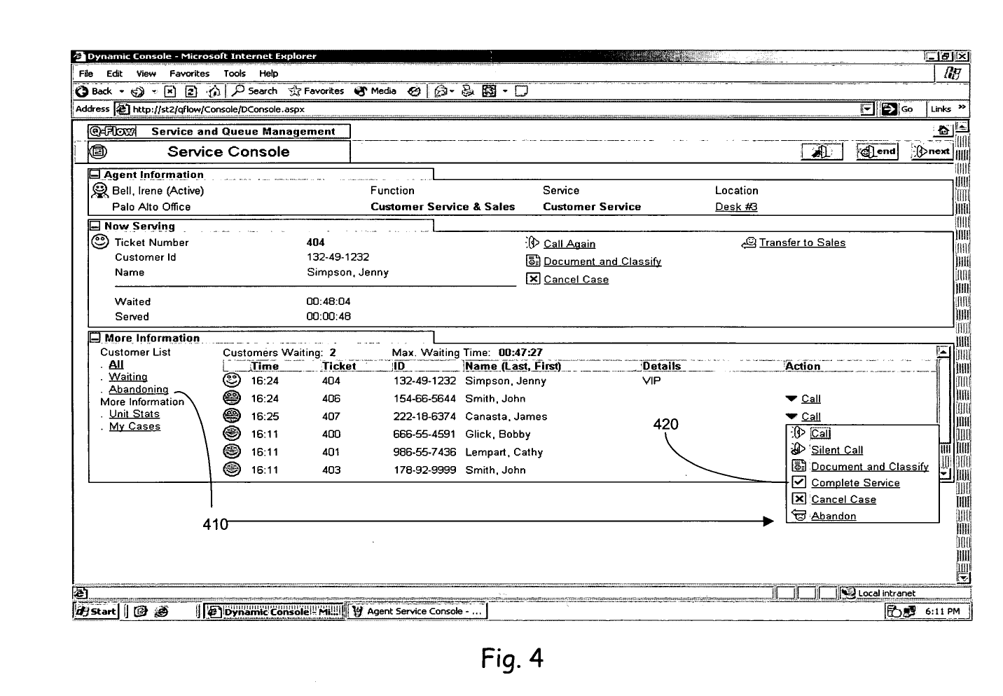

FIG. 4 is a screen shot illustrating Service Console 214, in accordance with the principles of the present invention. Prior art QMS terminals allow basic operations such as calling a customer from the queue, marking the customer as “abandoned” or transferred to another agent or queue. Abandoned 410 is QMS terminology for a customer tired of waiting in line and leaving before getting service

Q-Flow allows several innovative service operations as part of Service Console 214:

Return to Queue allows agents to bring abandoned customers back into the queue, as is necessary in cases where customers returned after going away for a few moments;

Complete Service 420 allows agents to report a customer was served without being called, as is necessary in cases where agents approach waiting customers in the waiting area in order to assist them; and

Freeze allows agents to put a customer on hold, to be automatically called back to service after a preset time, as is necessary in healthcare where a customer may be asked to lie down for an hour, and other services.

These features allow users to adapt the system to follow a variety of business processes, instead of changing processes to match system capabilities.

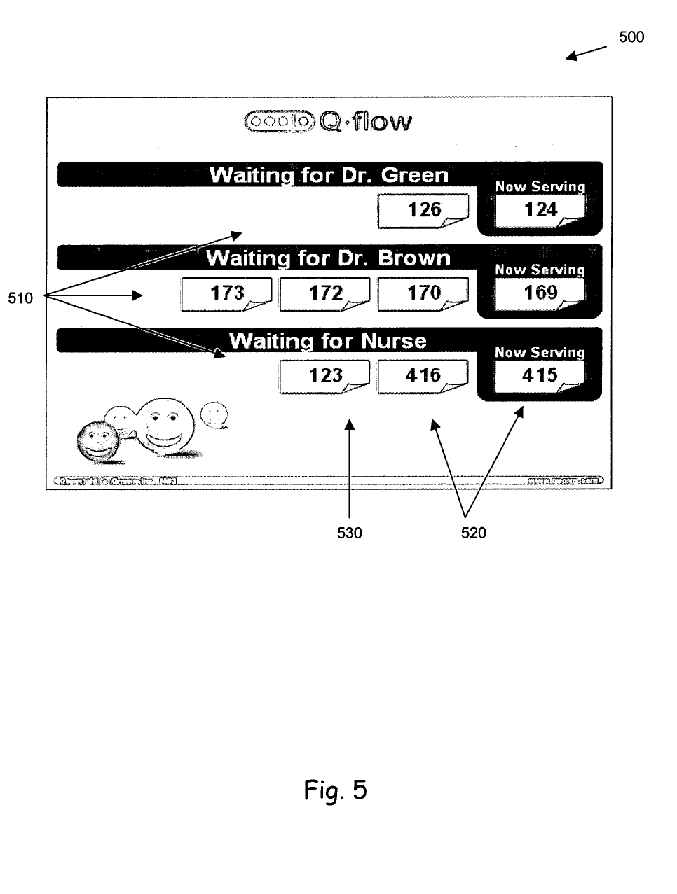

FIG. 5 is an InfoPage screen shot 500 on a TV or computer monitor, in accordance with the principles of the present invention. Prior art QMS displays provide general information for waiting customers, e.g., how many customers are waiting and which number is next, for every particular service. Q-Flow provides waiting customers with extensive information using the InfoPage display, a sub-component of Announcer 230. This display, accessible using a TV or computer monitor, provides a list of waiting customers 510 in each service, showing each customer 520 who is ahead of him in line. For example, if a customer 530 having number 123 is waiting for the nurse, then 415 is being served and 416 is also ahead of him.

This extra information allows customers to stay relaxed while waiting, particularly in environments where pre-scheduled and random visitors are mixed, and customers may suspect they have been overtaken by someone, or find it difficult to predict how much time they are expected to wait.

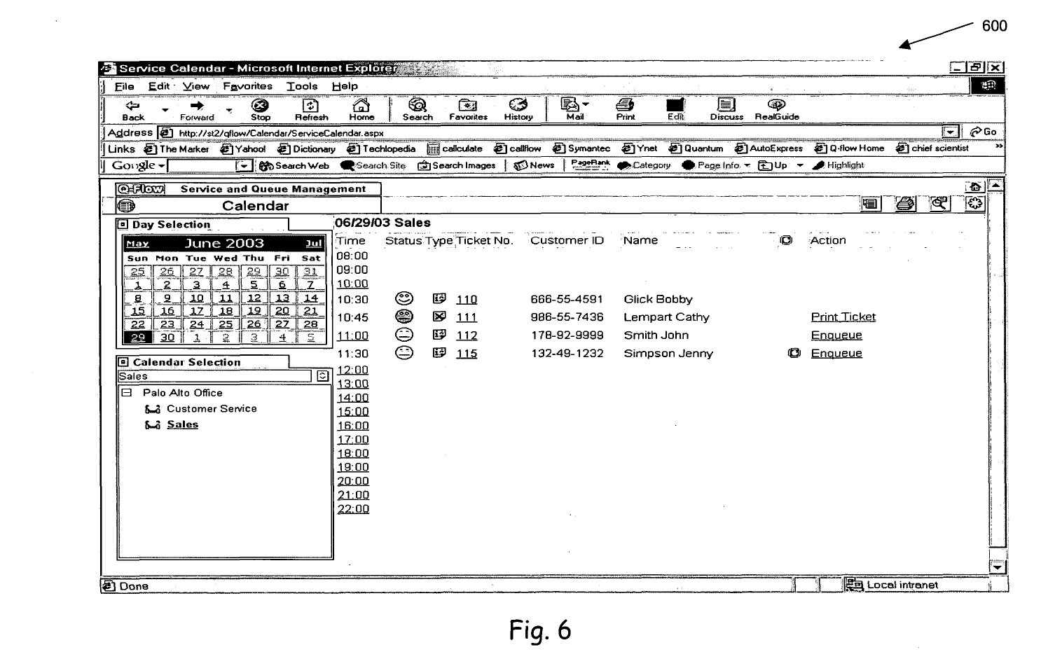

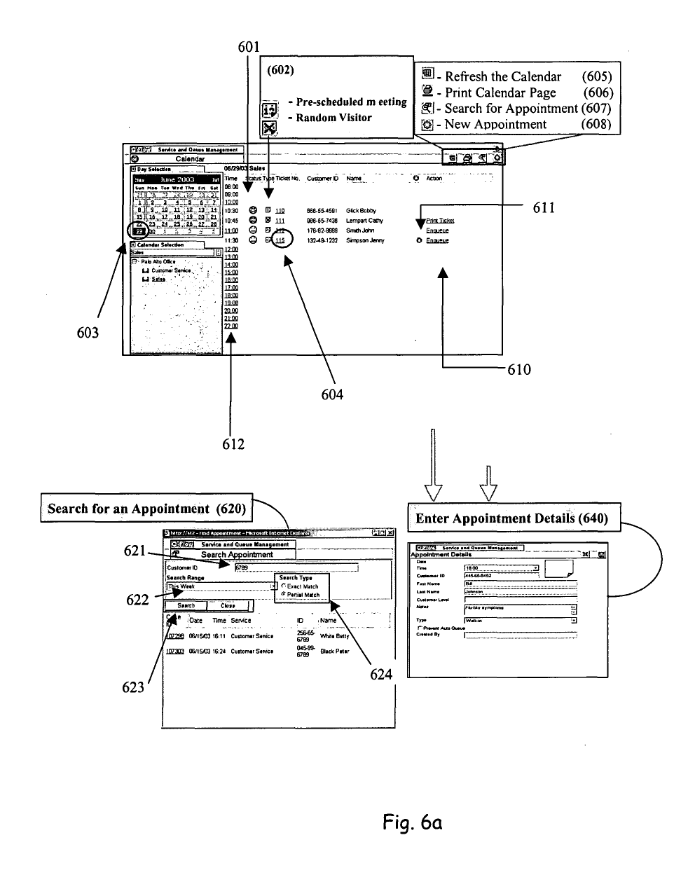

FIG. 6 is a general screen shot of the Calendar application 600, in accordance with the principles of the present invention. The Calendar application is accessible via browser, using Q-Flow Client 250 GUI application.

FIG. 6a shows detailed screen shots of the Calendar application, in accordance with the principles of the present invention. The Calendar is used for access to View, Add and Edit customer appointments. Screen shot calendar application 600 is repeated showing customer status 601 and customer type 602. The exact date is selected by clicking on a Calendar date icon 603. Editing an existing Appointment is done by clicking the Ticket Number 604. Icons are used for various functions:

Refresh the Calendar 605;

Print Calendar Page 606;

Search for Appointment 607; and

New Appointment 608.

Various actions 610 are performed upon making an Appointment:

Print another Ticket; and

Enter Customer into Queue.

The symbol shown as reference block 611 is used to mark when a customer is to be directed to a human receptionist and is not queued automatically by the reception kiosk. To add a New Appointment, click on the Hour 612 of an open time slot.

Another screen shot is exemplary for searching for an appointment 620. A small window is used to enter part or all of the customer ID 621. Another small window is used to select the search range period 622: Today; This Week; or This Month. A pair of buttons are used to start and close the search 623:

Click Search to begin search; and

Click Close to close the box.

A pair of markers are used to Select the Search Type 624:

Exact Match—numbers must match Customer ID exactly; and

Partial Match—numbers must be inside Customer ID.

Yet another screen shot is used to Enter Appointment Details 640.

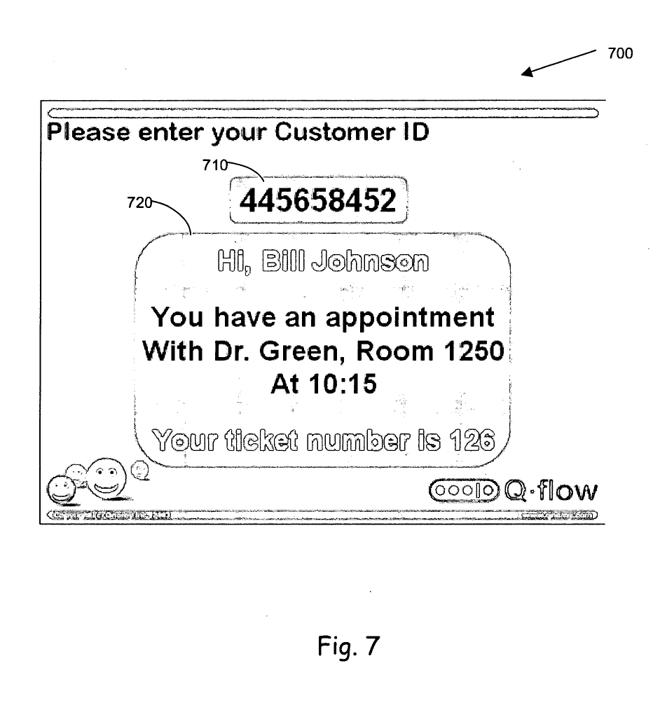

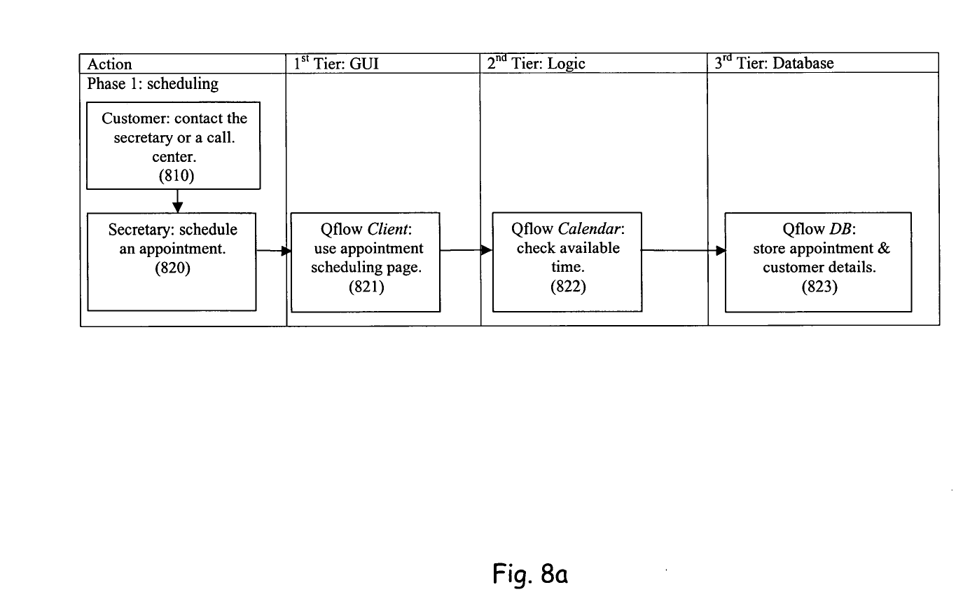

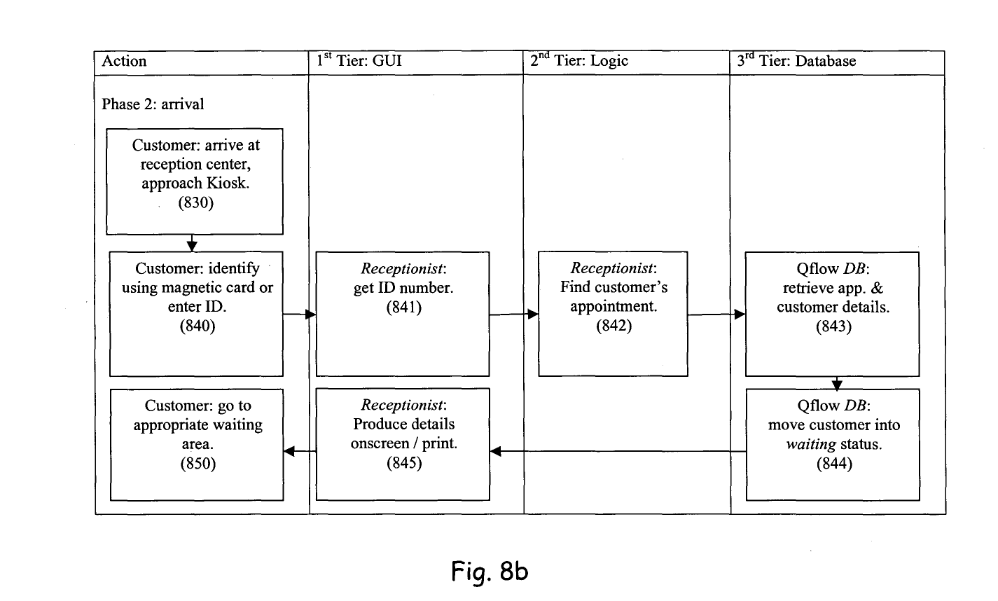

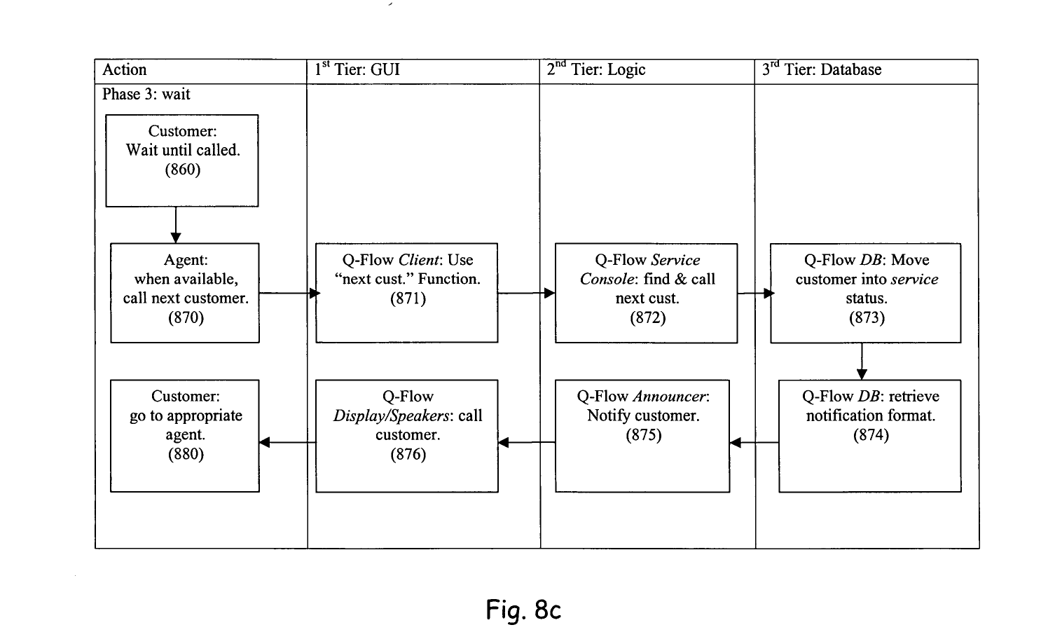

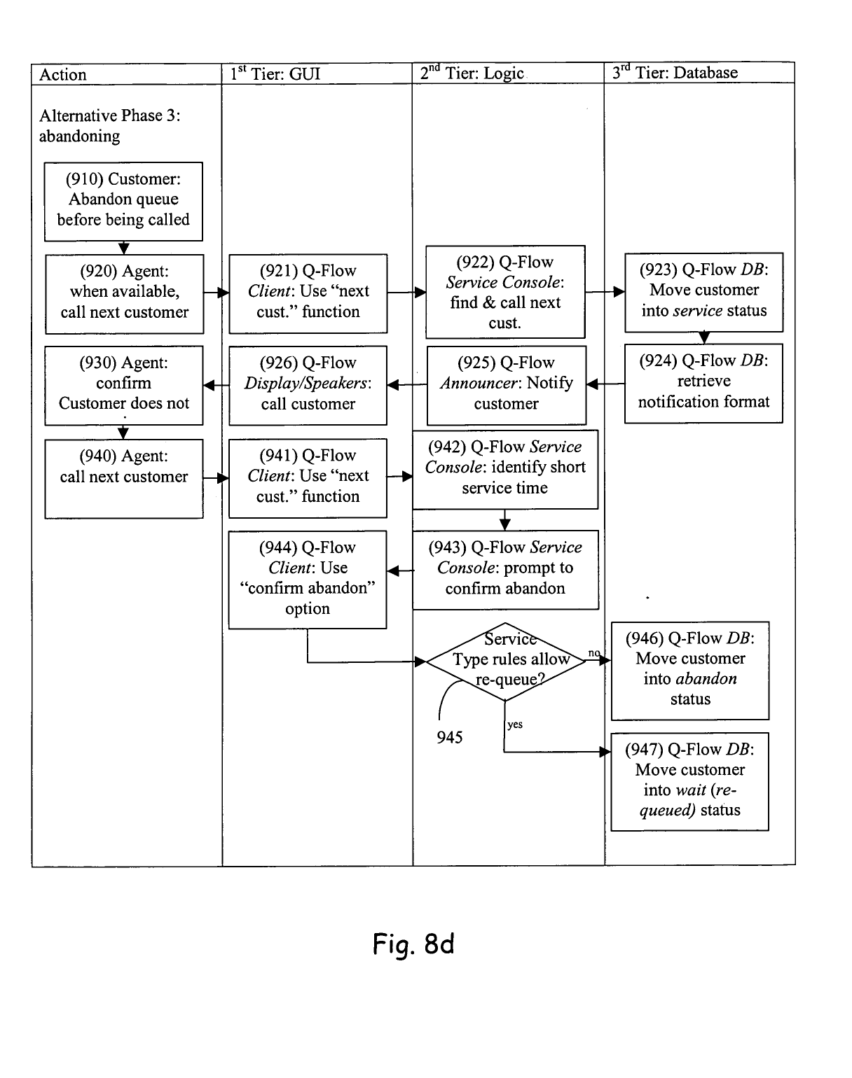

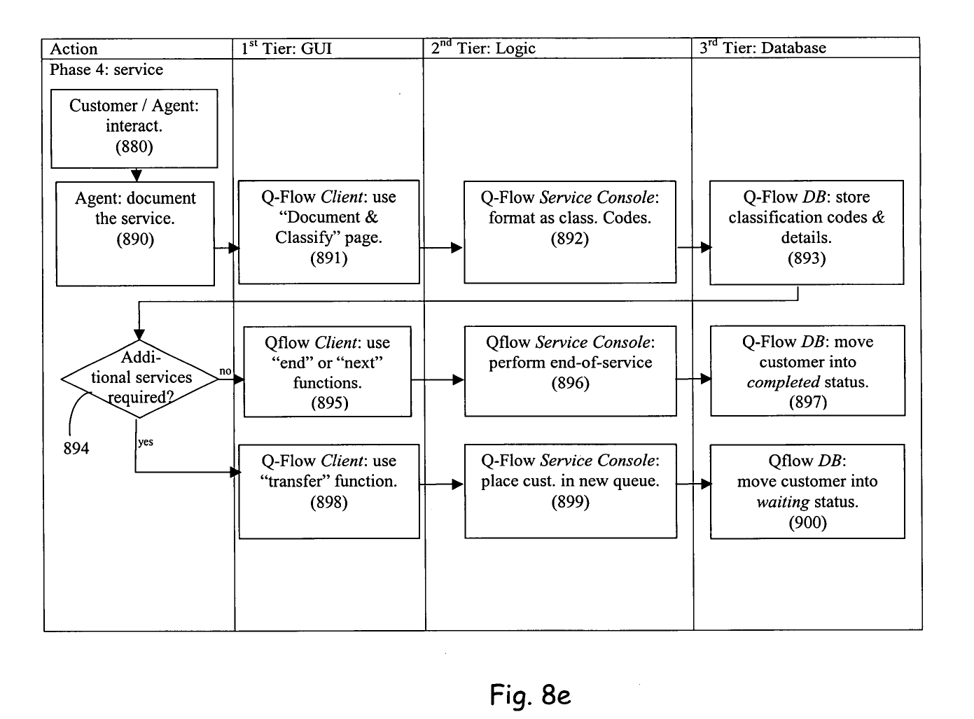

FIG. 7 is a Receptionist screen shot 700 on a TV or computer monitor, in accordance with the principles of the present invention. Upon arrival, the customer approaches the kiosk, for example, and enters his customer ID 710. A window 720 responds with the necessary information. More details are given in FIG. 8b below.

FIGS. 8a-8e are flow charts, constructed in accordance with the principles of the present invention. FIG. 8a is a scheduling flowchart. The first action is that the customer contacts the secretary or a call center 810. Then the secretary schedules an appointment 820. With reference to FIG. 2, the GUI of Q-Flow Client 250 uses an appointment scheduling page 821, as seen above in reference to FIG. 6a. Q-Flow Calendar 213 logic is used to check the available time 822, Q-Flow Database (DB) 220 stores the appointment and customer details 823.

FIG. 8b is an arrival flowchart. The first action is that the customer arrives at the reception center and approaches the kiosk 830. Then the customer identifies himself by using a magnetic card or by entering his ID 840. The receptionist software component, in coordination with the browser, gets the ID number 841, and then finds the customers appointment 842. The DB then retrieves the appointment and customer details 843, and moves the customer into waiting status 844. The receptionist then produces the details onscreen and prints those 845. In another action the customer goes to the appropriate waiting area 850.

FIG. 8c is a wait flowchart. The first action is that the customer waits until called 860. In another action the agent calls the next customer, when one is available 870. The Q-Flow Client then uses the browser to display the “next customer” function 871, and the Q-Flow Service Console finds and calls the next customer 872. Then the Q-Flow DB moves the customer into service status 873 and retrieves the notification format 874. The Q-Flow Announcer then notifies the customer 875 and the Q-Flow Speakers call the customer 876. In another action the customer goes to the appropriate agent 880.

FIG. 8d is an abandon flowchart, which is an alternative to the wait flowchart. The first action is that the customer abandons the queue before being called 910. In another action the agent calls the next customer, when one is available 920. The Q-Flow Client then uses the browser to display the “next customer” function 921, and the Q-Flow Service Console finds and calls the next customer 922. Then the Q-Flow DB moves the customer into service status 923 and retrieves the notification format 924. The Q-Flow Announcer then notifies the customer 925 and the Q-Flow Speakers call the customer 926. In another action the agent confirms the customer does not arrive 930 and then calls the next customer 940. The Q-Flow Client then uses the browser to display the “next customer” function 941, and the Q-Flow Service Console identifies the short service time 942 and prompts to confirm the abandon 943. The Q-Flow Client then uses the browser to display the “confirm abandon” option 944, and the Service Type rules decide whether to allow a re-queue 945. If so, then the Q-Flow DB moves the customer into abandon status 946, and if not moves the customer into wait (re-queued) status 947.

FIG. 8e is a service flowchart. The first action is that the customer and agent interact 880. In another action the agent documents the service 890. The Q-Flow Client then uses the “Document and Classify” page 891 and the Q-Flow Service Console formats as classification codes 892 and then the Q-Flow DB stores the classification codes and details 893 and retrieves the notification format 874. The Q-Flow Announcer then notifies the customer 875 and the Q-Flow Speakers call the customer 876. In another action the customer goes to the appropriate agent 880. It is then decided whether additional services are required 894? If so, the Q-Flow Client then uses the “end” or “next” functions 895, the Q-Flow Service Console performs the end-of-service 896 and then the Q-Flow DB moves the customer into completed status 897. If not, the Q-Flow Client then uses the “transfer” functions 898, the Q-Flow Service Console places the customer in a new queue 899 and then the Q-Flow DB moves the customer into waiting status 900.

The following is an optional mode of operation. As the customer arrives at the “Q-Flow Receptionist” kiosk and identifies himself, the system looks him up on the customer's database and finds a data-field noting whether he is in debt for previous services. For instance, at a clinic he might have left his previous treatment without paying the doctor's fee. If he is in debt, before forwarding the customer to the queue where he's supposed to wait, the system will ask the customer to pay the debt. He will be able to do that immediately, at the same kiosk, by passing his credit card through the same magnetic card reader he may have used to identify himself. If he pays, he will be transferred to the queue directly; if not, he will be transferred to a human receptionist.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

1. An open-architecture system for queue management of users that is hardware independent, said system comprising:
at least one Web-based server for an organization containing the logic and central systems functions;
a Web client application allowing interaction between the users and said web-based server, and accessible through a browser on client workstations;
a database installed on an Structured Query Language (SQL) server for record maintenance and interactions with said web-based server and said client application;
an announcer server for activating at least one of at least one of the following:
displays; and
speakers,
according to orders from said at least one Web-based server; and an automated receptionist for issuing tickets to, and otherwise interacting with, users.

2. The system according to claim 1, based on .NET technology.

3. The system according to claim 1, wherein said receptionist issues tickets via an automated ticket printer.

4. The system according to claim 1, wherein standard hardware may be attached to the system.

5. The system according to claim 4, wherein the system communicates with said standard hardware using standard drivers, for at least one of at least one of the following:
printers; and
speakers.

6. The system according to claim 4, wherein the system communicates with said standard hardware using specially customized drivers.

7. The system according to claim 1, wherein said Web client application is accessible through a browser on a handheld device.

8. The system according to claim 1, wherein said browser is used for other business applications.

9. The system according to claim 1, wherein said standard hardware comprises at least one wireless device.

10. The system according to claim 1, wherein the system inserts personal information into the ticket.

11. The system according to claim 1, wherein the system inserts personal information onto a display screen.

12. The system according to claim 1, wherein the system prints forms to be filled out.

13. The system according to claim 1, wherein the system prints marketing brochures.

14. The system according to claim 1, wherein the system administration functions comprising at least one of the following:
hardware configuration;
business logic; and
user ID and passwords can be performed from anywhere in said enterprise.

15. A method for an open-architecture .Net system for management of users comprising:
at least one Web-based server for an organization containing the logic and central systems functions;
a Web client application allowing interaction between the users and said Web-based server, and accessible through a browser on client workstations;
a database installed on an Structured Query Language (SQL) server for record maintenance and interactions with said web-based server and said client application;
an announcer server for activating at least one of at least one of the following:
displays; and
speakers,
according to orders from said at least one Web-based server; and
an automated receptionist for issuing tickets to, and otherwise interacting with, the users,
the method provides for queue management of users that is hardware independent, the method comprising:
scheduling, wherein the user contacts the secretary or a call center;
arriving, wherein the user arrives at the reception center and approaches the kiosk;
waiting, wherein the user waits until called; and
servicing, wherein the user and agent interact.

16. The method according to claim 15, wherein waiting further comprises abandoning, wherein the user leaves the queue.
